(19) United States
(12) Patent Application Publication
(10) Pub. No.: US 2006/0222753 A1
(43) Pub. Date: Oct. 5, 2006

(54) Substituted cacao products and methods

(76) Inventor: Christopher Harshberger, Washington, DC (US)

Correspondence Address: CONNOLLY BOVE LODGE & HUTZ LLP, SUITE 800, 1990 M STREET NW, WASHINGTON, DC, 20036-3425, US

(21) Appl. No.: 11/098,406

(22) Filed: Apr. 5, 2005

(51) Int. Cl. A23G 3/00

(52) U.S. Cl. 426/660

(57) ABSTRACT

The present invention relates generally to cocao products that are substantially free of cocoa powder, and particularly, but not by way of limitation, to cocao products in which all, or substantially all of the cocoa powder is replaced by finely ground coffee powder. An aspect of the present invention is a process by which a confection product having the good organoleptic properties of chocolate is obtained.

### FIELD OF THE INVENTION

The present invention relates generally to cocao products that are substantially free of cocoa powder, and particularly, but not by way of limitation, to cocao products in which all, or substantially all of the cocoa powder is replaced by finely ground coffee powder. An aspect of the present invention is a process by which a confection product having the good organoleptic properties of chocolate is obtained.

### BACKGROUND

The information provided below is not admitted to be prior art to the present invention, but is provided solely to assist the understanding of the reader.

Chocolate is a mixture of finely milled solids, chocolate liquor, sugar, milk crumb or powder, all suspended or well dispersed in cocoa butter and/or substitute fat, which at normal processing temperature is the liquid carrying medium. Generally, chocolate is prepared by mixing a cacao mass, fats and oils such as cacao butter or the like, cocoa, saccharides, milk powder and the like as required, and subsequently subjecting the mixture to rolling, conching and tempering. Raw materials such as chocolate liquor, sugar, water and milk are processed into chocolate through a series of processed steps including, for example, crumb making, paste mixing, refining, Usually, an emulsifier or an emulsifying system is added during conching.

Therefore, there is a need for a confection product that provides the organoleptic and gustatory properties of chocolate while providing a different range of taste sensations.

Other objects and advantages will become apparent from the following disclosure.

### SUMMARY OF INVENTION

The present invention meets the perceived need by embodying a confection product that provides the organoleptic and gustatory properties of chocolate while providing a different range of taste sensations.

An aspect of the invention provides a conched confection product, comprising a finely milled solid principle flavoring agent emulsified in an edible fat, provided that the confection product is substantially free of cocoa solids.

According to various aspects of the inventive confection product, the edible fat is selected from the group consisting of cocoa butter, lauric and non-lauric hard butters, nut butters, peanut butter, polyol esters, and mixtures thereof. In a preferred embodiment, the edible fat is cocoa butter.

According to an aspect of the invention, the solid principle flavoring agent is selected from the group consisting of coffee, chicory, dried malted cereal extract, yeast, nuts, spices, and mixtures thereof. According to a preferred aspect, the solid principle flavoring agent is coffee.

According to a further aspect, the conched confection product further comprises a sweetener. According to yet further aspects, the conched confection product comprises a milk product. Additional aspects of the invention provide the confection product comprises at least one accessory flavoring agent. According to additional preferred aspects the conched confection product comprises an emulsifier.

Aspects of the present invention provide methods of making a conched confection product substantially free of cocoa solids. According to an aspect the method comprises providing a principle flavoring agent as a finely milled solid, providing an edible fat, and forming a solid in oil emulsion by conching the finely milled solid in the fat.

According to various preferred aspects of the invention, the method further comprises providing any or all of sweeteners, milk products, accessory flavoring agents, and emulsifiers. According to further preferred aspects, the method comprises tempering the confection product.

An aspect of the present invention is a process by which a confection product having the good organoleptic properties of chocolate, but substantially free of cocoa solids is obtained.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

### BRIEF DESCRIPTION OF DRAWINGS

(N/A)

### DETAILED DESCRIPTION OF A PREFERRED EMBODIMENT

Chocolate is a mixture of finely milled solids, chocolate liquor, sugar, milk crumb or powder, all suspended or well dispersed in cocoa butter and/or substitute fat, which at normal processing temperature is the liquid carrying medium. Raw materials such as chocolate liquor, sugar, water and milk are processed into chocolate through a series of processed steps including, for example, crumb making, paste mixing, refining, conching and standardizing. Usually, an emulsifier or an emulsifying system is added during conching.

Conventional chocolate products generally contain about 30 to 60 percent sugar, about 10 to 70 percent chocolate liquor (which normally contains about 10 to 25 percent cocoa butter), about 20 to 25 percent added cocoa butter, and about 1 percent flavor and other constituents.

During conching, chemical and physical processes take place. These include the development of the full desirable chocolate flavor and the conversion of the powdery, crumbly refined product into the chocolate. Conching imparts shearing stresses and kneading action which serve both to liquify the masse and to positively influence and accelerate the flavor development processes. Important physical tasks of conching are to disperse, to dehumidify or remove moisture, to remove unwanted volatile flavors, to break up solid particle agglomerates, to round particle edges and to homogenize. Viscosity is lowered, and flowability and texture are improved.

The present invention relates to confection product having the desirable flavor release and organoleptic sensations of produced by chocolate, but that differs from chocolate in having a principle flavor that is not based on cocoa powder or cocoa liquor. According to an aspect, the present invention is a mixture of finely milled solid, non-cocoa, principle flavoring agent suspended or well dispersed in an edible fat. According to further aspects, additional confectionary ingredients, such as sugar, milk crumb or powder, accessory flavoring agents, and emulsifiers are suspended or well dispersed in the edible fat which may be cocoa butter and/or a substitute fat.

The present disclosure relates to a confection on a weight percent basis comprising:
(1) about 5 to 20 percent of a finely-milled solid principle flavoring agent;
(2) about 25 to 50 percent edible fat;
(3) up to about 70 percent sugar or sweetener;
(4) up to about 70 percent milk solids;
(5) up to about 1 percent lecithin;
(6) up to about 2 percent accessory emulsifier; and
(7) up to about 5 percent auxiliary flavoring agent.

Chocolate is a highly desirable confection product which has unique texture and flavor release properties in the mouth. Many of these desirable properties are generally attributable to the fat component of chocolate—cocoa butter—which has a narrow melting point range just slightly below normal body temperature and a sharp melting curve. Accordingly, the desirable flavor release and organoleptic sensations of chocolate occur rapidly as the chocolate melts in the mouth.

A first component of the present invention is an edible fat or other suitable oleaginous product. Particularly preferred is an edible fat or oleaginous product that has the melting properties of cocoa butter. Most particularly preferred is cocoa butter. The edible fat may be a cocoa butter alternative. Cocoa butter alternatives are vegetable fats such as cocoa butter equivalents (CBE) and cocoa butter substitutes (CBS) which are well known to those skilled in the art, e.g. CBS laurics and CBS nonlaurics (see Minifie, Chocolate, Cocoa, and Confectionery; Third Edition, Chapman and Hall, New York, 1989, [Bernard W. Minifie; AVI),] pp. 100-109. The term “edible fat” includes digestible materials and indigestible materials. Suitable edible fats are known to persons of skill in the confectionary arts. Suitable indigestible fats include polyol fatty acid polyesters and other materials disclosed in U.S. Pat. No. 5,518,754.

A second component of the present invention is a solid principle flavoring agent. In a preferred embodiment, the solid material is finely-milled. For the present disclosure, finely-milled relates to a particle size distribution where 90 percent of the particles are less than 100 microns. Preferably, 90 percent of the particles are from about 15 to 50 microns. The particles of the solid principle flavoring agent may have the desired size distribution prior to incorporation into the confection of the present invention. The desired size distribution may be obtained, in part, by an operation used to form the confection of the present invention. Such an operation may be conching. The solid principle flavoring agent may suitably be chosen from among, but is not limited to, such materials as coffee, chicory, dried malted cereal extract, yeast, nuts, spices, and mixtures thereof.

In a preferred aspect, the principle flavoring agent is coffee. The coffee may be caffeinated or decaffeinated. The coffee may be treated to enhance various flavors and aromas characteristic of coffee. Such treatments may include roasting and/or other treatments as is known to the coffee arts.

An aspect of the invention provides the substituted cacao product is substantially free of cocoa solids. Cocoa solids include, but are not limited to, cocoa powder and cocoa liquor. Cocoa solids include cocoa as defined in 21 CFR 163 Part B. Substantially free of cocoa solids is taken to mean less than 5 weight percent cocoa solids. Preferably, substantially free of cocoa solids is taken to mean less than 4 weight percent cocoa solids. More preferably, substantially free of cocoa solids is taken to mean less than 3 weight percent cocoa solids. Yet more preferably, substantially free of cocoa solids is taken to mean less than 2 weight percent cocoa solids. Most preferably, substantially free of cocoa solids is taken to mean less than 1 weight percent cocoa solids. Substantially free of cocoa solids is further defined to encompass the substantial absence of materials that impart flavors characteristic of chocolate. Dahlia preparations that impart chocolate flavors are disclosed in U.S. Pat. No. 4,564,525. The present invention encompasses yeast products that do not produce, or have not been treated so as to produce, flavors characteristic of chocolate. A roasted yeast product having the characteristic flavor and aroma of cocoa powder is disclosed in U.S. Pat. No. 4,312,890. Persons of skill in the confectionary arts can readily select yeast materials that do not impart chocolate flavors.

Sugar or artificial sweeteners with bulking agents are optionally present in the compositions of the present invention at a level of up to about 70 percent. In this disclosure and the appended claims, the terms “sugar” and “sweetener” denote a substance or mixture of substances imparting both bulk and sweetness to the confection product, and it may be sucrose or a sucrose substitute, such as fructose, glucose, a sugar alcohol (e.g. xylitol, sorbitol, mannitol, lactitol, maltitol, isomalt) or polydextrose or inulin together with a sugar alcohol and/or an intense sweetener (an artificial such as aspartame), or a mixture of these. The term sugar and sweetener may be used interchangeably for purposes of the present disclosure. Suitable sugars may include nutritive sweetener, including, but not limited to, sucrose, glucose, corn syrup, and high fructose corn syrup. The preferred sugar is sucrose. Other nutritive sweeteners can be used at equivalent levels to sucrose or as a substitute for a portion of the sucrose. The sugar may be granular cane or beet sugar. For some applications, a portion of the sugar may be powdered confectioners sugar. Artificial or non-nutritive sweeteners such as, but not limited to, aspartame, Sucralose™, or Alitame™ may be used in combination with a bulking agent such as polydextrose. Other sweeteners, such as D-tagatose or various polyols (e.g., sorbitol or xylitol) can be used with or without bulking agents to substitute for all or part of the sugar. A polydextrose may optionally be used in the compositions of the present invention in place of sugar if desired. Polydextrose can be prepared by the polymerization of glucose in the presence of food-acceptable polycarboxylic acid catalysts and polyols as provided in, for example, U.S. Pat. No. 4,622,233. Polydextrose can be used to replace all or part of the sugar, in which case the sweetening effect of the displaced sugar can be provided by a non-nutritive sweetener. For purposes of this invention, “sugar” is to include any suitable nutritive sweetener, or mixtures thereof, and “artificial sweeteners” is to include any suitable non-nutritive sweetener, or mixtures thereof, including those listed above. The sugar used is preferably in the form of a dry powder which may be crystalline or in the form of a slurry. The sugar used may be, for example, sucrose, glucose, dextrose, lactose, fructose, invert sugar, corn syrup solids or sugar replacers such as polyols. e.g. sorbitol, mannitol, xylitol, maltitol, lactitol, polydextrose, etc., or mixtures thereof.

Milk products are optionally incorporated into the confections of the present invention. Preferably the milk products are present as milk solids. The milk solids may comprise, for example, whole milk powder, whey proteins, yogurt solids, low fat milk solids, and mixtures thereof. The amount of milk solids may be up to about 70 weight percent based on the total weight of the mixture.

Accessory flavorings up to about 5 weight percent are optionally incorporated into the confections of the present invention. Accessory flavorings include, but are not limited to vanilla, spices, and fruit flavor. The accessory flavors may be natural or artificial. Persons of skill in the confectionary arts may readily chose suitable flavorings.

Up to about 2 weight percent lecithin is optionally incorporated into the confections of the present invention as a primary emulsifier. In embodiments in which the edible fat is present substantially entirely as cocoa butter, it is preferred that lecithin is the sole emulsifier. Lecithin is normally present in conventional chocolate products. Although not wishing to be limited by theory, it appears that lecithin's role appears mainly to control and adjust the flow properties of the molten chocolate during processing. Thus, lecithin is used to reduce the viscosity of molten chocolate and is very important for molding and transferring operations during manufacture. Lecithin does not appear to play an important role in regard to mouthfeel. Lecithin may, however, coat the sugar and other particles in the chocolate and assist in keeping them dispersed. In certain embodiments it may be preferred to incorporate up to about 10 weight percent of a soya protein isolate as an emulsifier. Supro 620 (manufactured by Ralston Purina Company, St. Louis, Mo. 63177) is a suitable soya protein isolate.

In certain embodiments, the edible fat is selected from higher (than cocoa butter) melting fats and sucrose esters. In these embodiments, it is preferable to incorporate a second emulsifier. Second emulsifiers are disclosed in U.S. Pat. No. 5,518,754. The second emulsifier appears to be related to the mouthfeel properties in that it can modify the crystalline and amorphous structure of the composition. This effect reduces the waxy mouthfeel which may result from the use of higher melting point fats and sucrose fatty acid polyesters. This second emulsifier appears to generally allow use of a wider range of sucrose fatty acid polyesters and/or hydrogenated oils without a significant increase in the overall waxiness of the chocolate product. Generally the second emulsifier is selected from the group consisting of lactylated glycerides, sorbitan esters, acetylated glycerides, polysorbate esters, and polyglycerol esters. Preferred second emulsifiers include, for example, sorbitan mono- and tristearates, lactic acid esters of mono- and diglycerides, acetylated monoglycerides, polysorbate esters, and polyglycerol esters. More preferred second emulsifiers include lactic acid esters of mono- and diglycerides and sorbitan mono- and tristearates. Mixtures or blends of the various second emulsifiers can also be used. Where first and second emulsifiers are used, the first emulsifier, lecithin, is generally in the range of about 0.2 to 1.0 percent, and preferably about 0.25 to 0.5 percent. The second emulsifier is generally in the range of about 0.1 to 1.5 percent, and preferably about 0.75 to 1.0 percent. Generally, the total amount of the two emulsifiers (i.e., lecithin and the second emulsifier) is in the range of about 0.5 to 2.0 percent, and preferably about 0.75 to 1.25 percent. The weight ratio of lecithin and the second emulsifier is preferably in the range of about 1:1 to 1:4.

The present disclosure also relates to methods and processes for preparing the confections of the present invention. The preparative methods are essentially those for preparing chocolate. The basic methods for making chocolate and the effect of the different steps of the processes on the properties of the final product have been described, for instance, in Minifie, B. W., Chocolate, Cocoa and Confectionery, Third Edition, Chapman and Hall, New York, 1989, pp. 107-125. The entire publication is incorporated by reference.

In a first step of the process, a base mass is formed of the raw materials (sweeteners, primary flavor agent, edible fat, and milk solids as appropriate) by mixing and kneading them into a homogeneous, plastic mass. This base mass is optionally processed further by roller refining, the main purpose of which is to diminish the particle size. The optionally roller refined base mass is further treated by mechanical heat treatment, i.e. conching, prior to or during which the remainder of the cocoa butter and the possible emulsifiers, flavours and intense sweeteners are added.

Conching machines knead the chocolate paste during controlled temperature excursions of form about 130 to about 200° F. This process develops flavors and changes the texture. Conching allows the separate flavors of the individual ingredients to combine. Conches (the paddles of the early machines resembled conch shells) are equipped with heavy rollers that plow back and forth through the paste, anywhere from a few hours to several days. Contemporary technologies can grind the chocolate particles extremely fine, which can reduce conching times. Swiss and Belgian chocolates, are conched as much as 96 hours. Some chocolates are not conched at all, or for only 4 to 12 hours. During the conching the final taste of the confection is developed and the desired consistency of the mass is achieved. Conching as such is known in the confectionary arts and to persons of skill will readily be able to determine optimal conditions of time and temperature (cf. the above book by Minifie, p. 123.

Where confections analogous to milk chocolate are desired a main portion of the raw materials may be formed into a crumb as is standard in the chocolate confectionary arts. In the crumb process specifically developed for producing milk chocolate with special flavor properties, the main part of the raw materials, i.e. sucrose, cocoa liquor and ingredients derived from milk and part of the cocoa butter, are formed into a solid granular intermediate, referred to as crumb, by mixing and vacuum drying/kneeding the ingredients. The crumb may be subjected to refining and conching with the rest of the raw materials.

In certain cases, the milk products may have an unacceptably high moisture content and or may possess off-flavors. The unwanted flavors and excess moisture may be removed in the process known as the CMC process (Chocolate liquor-Milk powder-Compounded process), which has been known since about 1980. Off-flavors and moisture are removed from mixes of solid principle flavor agent/milk powder mixes in a Petzomate apparatus in which the mass is sprayed downwards in a thin film into a stream of hot air rising upwards.

### INCORPORATION BY REFERENCE

All publications, patents, and pre-grant patent application publications cited in this specification are herein incorporated by reference, and for any and all purposes, as if each individual publication or patent application were specifically and individually indicated to be incorporated by reference. In the case of inconsistencies the present disclosure will prevail.

Having thus described our invention, what we claim as new, and desire to secure by Letters Patent is:

1. A conched confection product, comprising:
an emulsion of a finely milled solid principle flavoring agent; and
an edible fat, wherein said confection product is substantially free of cocoa solids.

2. The conched confection product, according to claim 1, wherein said edible fat is selected from the group consisting of cocoa butter, lauric and non-lauric hard butters, nut butters, peanut butter, polyol esters, and mixtures thereof.

3. The conched confection product, according to claim 2, wherein said edible fat is cocoa butter.

4. The conched confection product, according to claim 1, wherein said solid principle flavoring agent is selected from the group consisting of coffee, chicory, dried malted cereal extract, yeast, nuts, spices, and mixtures thereof.

5. The conched confection product, according to claim 4, wherein said solid principle flavoring agent is coffee.

6. The conched confection product, according to claim 1, further comprising a sweetener.

7. The conched confection product, according to claim 1, further comprising a milk product.

8. The conched confection product, according to claim 1, further comprising at least one accessory flavoring agent.

9. The conched confection product, according to claim 1, further comprising an emulsifier.

10. A method of making a conched confection product comprising:
providing a principle flavoring agent as a finely milled solid;
providing an edible fat; and
forming an emulsion thereof by conching said finely milled solid in said fat, wherein said confection product is substantially free of cocoa solids.

11. The method of making a conched confection product, according to claim 10, wherein said edible fat is selected from the group consisting of cocoa butter, lauric and non-lauric hard butters, nut butters, peanut butter, polyol esters, and mixtures thereof.

12. The method of making a conched confection product, according to claim 10, wherein said solid principle flavoring agent is selected from the group consisting of coffee, chicory, nuts, dried malted cereal extract, spices, and mixtures thereof.

13. The method of making a conched confection product, according to claim 10, further comprising providing a sweetener.

14. The method of making a conched confection product, according to claim 10, further comprising providing a milk product.

15. The method of making a conched confection product, according to claim 10, further comprising providing at least one accessory flavoring agent.

16. The method of making a conched confection product, according to claim 10, further comprising providing an emulsifier.

17. The method of making a conched confection product, according to claim 10, further comprising tempering said product.

18. The method of making a conched confection product, according to claim 14, further comprising:
providing at least a portion of said edible fat;
providing at least a portion of said milk product;
providing at least a portion of said principle flavoring agent; and
forming a crumb thereof.

19. The method of making a conched confection product, according to claim 10, wherein said conching is performed in a Petzhold conch.
